(19) United States
(12) Patent Application Publication
(10) Pub. No.: US 2013/0232075 A1
(43) Pub. Date: Sep. 5, 2013

(54) SYSTEM AND METHODS FOR TRANSFERRING MONEY

(71) Applicants: Stephen Robert Monaghan, Chatswood (AU); Shaun Robert Warren, Clementi (SG); Arthur Fewell Lees-Rolfe, Pretoria (ZA)

(72) Inventors: Stephen Robert Monaghan, Chatswood (AU); Shaun Robert Warren, Clementi (SG); Arthur Fewell Lees-Rolfe, Pretoria (ZA)

(21) Appl. No.: 13/811,150

(22) PCT Filed: Jul. 20, 2011
(86) PCT No.: PCT/US11/44700

§ 371 Date: Mar. 28, 2013

Related U.S. Application Data
(60) Provisional application No. 61/366,029, filed on Jul. 20, 2010.

(51) Int. Cl. G06Q 20/38

(52) U.S. Cl. CPC G06Q 20/385
USPC 705/44

(57) ABSTRACT

Aspects of the present invention relate to systems and methods for increasing security and privacy of financial transactions. More specifically, certain aspects of the invention provide consumers, financial institutions, and/or merchants with increased protection of sensitive information associated with financial accounts and transactions. Herein disclosed are methods and systems for allowing a consumer to pay a merchant without the consumer needing to disclose confidential information to the merchant.

### CROSS REFERENCE

This application claims the benefit of priority to U.S. Provisional Application 61/366,029 filed Jul. 20, 2010, the contents of which are incorporated by reference in their entirety.

### FIELD OF THE INVENTION

Aspects of the present invention relate to systems and methods for increasing security and privacy of financial transactions. More specifically, certain aspects of the invention provide consumers, financial institutions, and/or merchants with increased protection of sensitive information associated with financial accounts and transactions.

### BACKGROUND OF THE INVENTION

Current infrastructure for an electronic transaction generally relies upon one of intermediary based stored value cards (e.g. gift cards), credit cards, and debit cards. Use of these cards can lead to breaches of a user's privacy. One advantage of a stored value card is that stored value card purchases are generally anonymous. In general, the amount of money on these cards is stored in a database which is queried based upon a unique identifier or identifiers on the card. (The card itself may contain the record of the value, if the card is readable and writable.) Money can often be added to a stored value card by a intermediary through a process known as recharging the card. To do this, typically the intermediary requires that the consumer register some personal financial information with them, either their bank account details, or credit card data, etc, so posing both a potential security and privacy risk to the consumer as in most cases the intermediary is not a financial institution.

Debit cards are also used to effectuate payment from a single bank account and allow a transaction against that account. Some debit cards allow one to spend more than is in the account by allowing the consumer to go into debt with the financial institution (rather like using a credit card). The use of a debit card—unless used in a cardholder not present mode such as a purchase over the interne—typically requires that there is the correct hardware device attached to the point of sale of the merchant. Some debit cards have as part of their card number the bank account number that the consumer has with the issuing financial institution thus providing part of the information that a potential identity thief needs. At the time of consummating a transaction, the merchant may collect and store the information that the consumer has provided—card number, expiry date, signature and/or pin—in their systems. Moreover, it is common for each financial institution that has issued a debit card to supply each merchant with a device to read the card and to transmit data to it. This often results in the merchant having multiple devices to keep at the point of sale. Some debit cards are linked to other bank accounts via the merchant's system to allow for automatic recharging of a debit card.

Credit cards and their account number are associated with a line of credit issued to a consumer from a financial institution. The credit card allows the consumer to make purchases and deplete that line of credit. In order to charge a debit to a credit card account, a merchant typically needs a credit card reader. In order to obtain a credit card, the consumer is often required to provide the company issuing the credit card service with extensive banking and/or personal information. Some credit cards have as part of their card number the bank account number that the consumer has with the settling financial institution thus providing part of the information that a potential thief needs. At the time of doing a transaction, the merchant may collect and store the information that the consumer has provided—card number, expiry date, signature and/or pin—in their systems.

In debit and credit card models, the consumer's name, financial institution and potentially the consumer's account is identified through the card itself. Often the financial institution may be identified by reviewing the identification of the card and deriving the financial institution through referencing a database. The financial institution also may control a database linking the card to the consumer's account. The duplication or spreading of banking information to multiple parties outside the banking environment places the consumer at a higher risk for fraud or identity theft. There are numerous instances of the theft of card numbers and associated consumer information. For example, a recent example of personal information being stolen from 130 million plus cards—is found here:—http://news.bbc.co.uk/2/hi/business/8206305.stm. In this example, the accused thief has been charged with stealing information about both credit and debit cards. The thefts were from the systems of the merchants, not the financial institution.

One of the inventors of the present invention developed a system aimed at providing a system for performing a transaction which reduces the necessity for confidential information to be forwarded to intermediates in the payment process flow. US 2004/0030645 (filed Apr. 16, 2001 herein incorporated by reference in its entirety). To achieve this end, the '645 publication discloses a process flow including, inter alia, the following steps. A consumer selects a product or service to be purchased from a merchant. To purchase the product, the consumer can: provide a barcode, enter information on a web interface, or in some other manner provide identification to the merchant, so as to enable the consumer to be identified by the system. Upon receipt of this identification, the merchant effectively generates an invoice for the product or the service and forwards this invoice to the system. The system then routes copies of the invoice to the consumer's financial institution and also to the merchant's financial institution. Contact is then made between the consumer and the consumer's financial institution by any bank interface channel so as to seek approval and authentication from the consumer for the purchase of the goods or service. Assuming that the purchase is legitimate, and that sufficient funds are in the consumers account, the consumer authorizes and authenticates the transaction by entering a password or some other means established to indicate that the consumer approves of the transaction. On receipt of the consumer's approval, the consumer's financial institution sends a message to system indicating approval. The system then acknowledges this approval to the merchant who then releases the goods or service to the consumer. The consumer's financial institution can also send the approval to the merchant's financial institution and through existing bank payment processing infrastructure payment can be made from the consumer's financial institution to the merchant's financial institution.

US Patent 2005/0256806 discloses a method for handling online transactions. U.S. Pat. No. 7,376,587 discloses a method for transferring money online, aimed at the person to person market. U.S. Pat. No. 7,155,411 discloses a method of storing a consumer's financial account information of one or multiple accounts in one device, and referencing one at the time of transaction. The consumer's details are stored in the said device, and the chosen details are passed to the merchant at the time of transaction. US Patent Publication 2007/0073629 discloses a method of acting as a clearing house for transactions. Payment is made to the clearing house and the clearing house forwards payment onto the merchant in a manner that is aimed at securing the consumer's financial data. U.S. Pat. No. 7,657,489 discloses a method of allowing a consumer to pay for a transaction using their payment processor, with money that the payment processor already has or will get from the consumer's bank account. Patent WO00/45320 discloses a system of using no tokens to identify oneself for a transaction, the identification is done by a biometric methodology. The method calls for the consumer to register themselves with the system and to provide biometric and financial information. Application 2003/0126075 proposes a method of online funds transfer. The consumer registers themselves to the system so that the system can facilitate the request for payment and a debit request on a bank account of the consumer. In one embodiment there are ‘Agents’ that can move money between consumers and merchants. U.S. Pat. No. 6,363,363 is a system that inter alia provides for electronic wallet functionality. To achieve this the invention requires that the consumer registers with the invention and supplies such information as name and banking details.

### SUMMARY OF THE INVENTION

Aspects of the present invention seek to overcome some of the short comings of the prior art. For example in the '645 publication, the disclosure required the consumer to provide some level of personal information (such as a phone number) so that the transaction could be identified to the correct consumer; and that the information held by the payment processor is simply a summary of the invoice details of the transaction. Certain embodiments of the present invention overcome these limitations by ensuring privacy by not requiring any private or identifiable information of the consumer to be supplied. In addition, some embodiments of the invention can be built/used so that the payment processor now holds the full and complete invoice or till register data about the transaction, and not an abridged version. This allows the payment processor to link with the individual product codes purchased, so that the platform can query additional information from the product code. In some embodiments of the invention the payment processor will pass the information obtained from the till register—which in some cases will include product codes and serial numbers—back to the supply chain of the manufacturer or supplier of the product in order to obtain information that the consumer will find useful. Such information can include the ingredients included in a product, or the components of a product. This is particularly relevant to consumers who are allergic to one or more particular ingredients (say peanuts). Additionally, particularly in the case of serial numbers or other unique identification codes, the payment processor may supply back to the consumer a confirmation or otherwise that the serial number of the product that they are purchasing is valid or not. In some embodiments of the invention this information can be relayed back to the consumer whilst they are still at the till register. Some of the limitations of the '806 publication include:—that the payment processor stores personal or detailed information about the consumer paying prior to the payment being made. In registering with the payment processor, the consumer gives personal and banking information in return for a user name and password. Certain embodiments of the present invention overcome these limitations by never requesting, soliciting, or accepting information regarding the identity of the consumer in the transaction.

Some of the limitations of the '587 patent include:—that the consumer must provide full personal details of themselves to the payment processor to be party to the transaction, and that the money goes to the payment processor prior to going to the intended recipient. Certain embodiments of the present invention overcome these limitations by never requiring that the consumer provide personal data to the transaction platform. In addition, in some configurations, the consumer does not pay any money to or through the transaction platform; rather payment is sent from financial institution to financial institution.

Some of the limitations of the '411 patent include:—that the consumer is providing his or her personal and banking information to a third party, and trusting that the third party (and the third party computers) are honest with the information and diligent enough to protect the information from hackers. At the time of transaction, the consumer's banking data is passed to the merchant's systems for the merchant to use in finalizing the transaction. Certain embodiments of the present invention overcome these limitations: by never holding any personal or banking information of the consumer in the transaction platform, and never passing any personal or banking information to a merchant; thereby eliminating the target to would-be hackers.

Some of the limitations of the '629 publication include:—the merchant's financial details are required by the clearing house to achieve the functionality of the clearing house. In addition, money is paid from the consumer to the clearing house and then it is delivered to the merchant. Certain embodiments of the present invention overcome these limitations, by building a payment processor which does not request, solicit, or accept information of the merchant regarding their banking information. In addition, some embodiments of the invention do not pay or pass any money through the transaction platform.

Some of the limitations of the '489 patent include: requiring the consumer to register with a payment processor and set up a pre-paid account that allows the payment processor to remove money from the consumer's bank account and put the money into an intermediary account. The payment processor also provides transaction codes for the transaction which are not guaranteed to be unique. Certain embodiments of the present invention overcome these limitations by instructing the payment processor to never request, solicit, or accept consumer information. Rather only the consumer's financial institution contains the consumer information. Also, some embodiments of the invention feature a payment processor which does not receive money from the consumer, nor passes money from the consumer to the merchant. Additionally, certain embodiments of the invention feature a payment processor which provides one time codes that are individually unique, and cannot be duplicated over time.

Some of the limitations of the WO 00/45320 patent include that the consumer needs to provide both private and banking information to the system in order to be registered to the system.

Some of the limitations of the '075 application are that the consumer once again is required to provide both personal and banking information. In addition, in some instances the system would act as an escrow agent, holding money from one party that will become due to another. Certain embodiments of the present invention overcome these issues by never requiring or knowing any personal or banking information of the consumer, and in addition, the present invention will never hold any money of any other party, as that responsibility lies with the financial institutions. Some of the limitations of the '363 patent are once again that the consumer is required to divulge personal and banking information to an institution that is not a financial institution, and so places their information and money at potential risk as a result.

In a first exemplary embodiment of the invention a payment process and a system is disclosed for enabling a consumer to make a payment to a merchant, said process can utilize: a consumer account at a financial institution registered with the consumer, a merchant account at a financial institution registered with the merchant, and a payment processor having a database. The process may have one or more the following steps which may be performed in varying sequences. Similarly in a system embodiment the system would contain software for executing the following processes. Providing the consumer with a secure session to enable the consumer to send confidential information to the consumer's registered financial institution; said secure session containing no code or instructions to enable or allow the consumer to send confidential information to any entity other than registered consumer financial institution. Confidential information can include a consumers personal information such as social security number, address, phone number etc., and can include banking information such as account numbers, user names, balances, etc. Maintaining at all times confidentiality of the consumer's confidential information, and ensuring that the merchant does not and cannot obtain access to the confidential information. Said payment processor issuing instructions to the consumer's financial institution on how to generate a one time code; said instructions requiring: the one time code not to contain any confidential information about the consumer; and the one time code to be unique, meaning that two financial institutions will not issue the same one time code; nor will the same financial institution issue two identical one time codes. The consumer requesting a one time code from the consumer financial institution. The financial institution using a one time code generator to create the one time code; and associating the one time code with a particular CHandle in a database controlled the consumer financial institution. The consumer providing the one time code to the merchant. The merchant submitting a payment request to the payment processor to obtain payment from the consumer via the consumer's registered financial institution. Said payment request may contain an invoice, the one time code, and an MHandle associated with the merchant. The payment processor using the one time code to determine which financial institution to transmit the merchant's payment request to. The payment processor transmitting the payment request to the consumer's financial institution for payment approval. The financial institution determining which account to transmit payment from by referencing a database which links the one time code with the CHandle. Said financial institution using the secure session to send the consumer associated with said account an authorization request to make payment. Said consumer transmitting a response to the financial institution using the secure session. Said financial institution sending the response to the payment processor. If the response is a positive authorization to pay the merchant; said payment processor sending a positive confirmation notice to the merchant indicating that the payment request was authorized. If the response is a negative authorization to pay the merchant; said payment processor sending a negative confirmation notice to the merchant indicating that the payment request was declined. If the response is a positive authorization to pay the merchant; said financial institution making payment to the merchant account at the financial institution registered with the merchant. The consumer financial institution sending payment to the merchant financial institution by determining a bank identifier from the MHandle included in the payment request, and using the bank identifier to determine which bank to pay. Transferring payment and a copy of the MHandle to the merchant financial institution. The merchant financial institution determining which merchant account to credit by referencing a database containing an association of merchant accounts with the MHandle. Sending the merchant a message the account associated with a particular MHandle has been credited. The CHandle may include an identifier for the consumer financial institution and a unique number used to determine the consumer account. The MHandle may include an identifier for the merchant financial institution and a unique number used to determine the merchant account. The one time code may include an identifier for the consumer financial institution, a time code, and a unique number used to determine the consumer account. The consumer financial institution checking to determine whether there is sufficient funds in the consumer's account to make the requested payment; and if the financial institution reaches a negative determination, sending a message to the consumer that there is insufficient funds in the account to cover the purchase, and sending the payment processor that the payment request is declined. The consumer financial institution sending the payment processor the one time code, after it sends the consumer the one time code. The consumer providing the one time code to the merchant via a mobile device, said one time code represented as a bar code. The consumer providing the one time code to the merchant by communicating an alpha-numeric representation of the one time code. The financial institution automatically rejecting the payment request once a certain period of time has elapsed after the one time code has been generated. Registering the consumer financial institution with the payment processor by providing a first unique financial institution identifier to the payment processor, and the payment processor sending the consumer financial institution a handle generator which utilizes the unique identifier to generate a CHandle. Registering the merchant financial institution with the payment processor by providing a second unique financial institution identifier to the payment processor, and the payment processor sending the merchant financial institution a handle generator which utilizes the unique identifier to generate a MHandle. Registering the consumer to effect payments with the payment processor by the consumer financial institution providing a registration module, having the consumer select an account to register, and having the consumer financial institution generate a CHandle based on the account, the first identifier, and a first unique number. Registering the merchant to receive payments with the payment processor by the merchant financial institution providing a registration module, having the merchant select an account to register, and having the merchant financial institution generate a MHandle based on the account, the second identifier, and a second unique number. The consumer financial institution linking the one time code with the CHandle so that a database at the consumer's financial institution records which one time code is associated with which CHandle. The consumer financial institution providing the payment processor with a copy of the CHandle once issued. The payment processor generating a record of payment requests submitted by a merchant including the one time code, the amount requested, and the MHandle. The payment processor determining the CHandle from the one time code. Generating a moniker by searching the database of the payment processor for all CHandles and MHandles associated with a particular entity, and associating a single unique code called a moniker with the CHandles and MHandles of the entity. The payment request additionally comprising: product identification codes of products being purchased by consumer, and pricing and quantity information of the products being purchased. The payment processor's database may contain CHandles, MHandles, invoices, and one time codes, but would not include any personally identifiable banking or personal identity information. The payment processor's database may contain information about one or more products that have been purchased by one or more consumers. The database contains monikers. The database may contain information including product codes of the products purchased, a quantity of items purchased in a single transactions, and unit pricing of the product. The database may contain information on the temperature that the products should be stored at, expiry dates, ingredients, and nutritional information. The payment processor may provide a value added service by alerting a consumer when a product purchased contains a certain ingredient. The payment processor may provide a value added service by tracking warranty information about the product purchased without providing information about the consumer to the merchant or manufacturer of the product. The payment processor may provide a value added service by determining whether the merchant has the product to be purchased in stock. Again, all the above features are exemplary only, and the above list includes possible features in a particular embodiment of the invention which may or may not contain all these features.

Configurations in which the invention could be constructed may also include a system that allows a consumer to make a financial transaction without passing any personal or banking information to any party other than its own financial institution; such system comprising: a transaction processor, a financial institution that has registered said consumer into their system as being a user of the transaction processor, a one time code issued by the financial institution, a third party that would typically be a merchant that is to receive payment, a database of transactions whether consummated or rejected. The following additional features may be included in such a system. The financial institution providing a secure means for the consumer to communicate with them for the purpose of the consumer obtaining said one time code. The communication system can comprise any of the financial institution's own current or future means or modes of communication to its systems from its consumers, using the levels of security and authentication requirements the financial institution itself authorizes or approves. The third party submitting a request for the consumer to make a payment to the transaction processor. The payment processor passing said request onto the consumer's financial institution for payment approval. The financial institution communicating to said consumer and obtaining authority to confirm said payment request. The financial institution communicating to the payment processor the result of the request for confirmation by the financial institution's consumer of the payment request. The payment processor confirming said financial intuitions' message on to the third party that is requesting payment. The financial institution making payment to the financial institution of the third party in terms of the payment obligation that the consumer consented to. The transaction can take place anonymously between any two parties, it is not necessary for one of them to be a merchant and the other to be a consumer. The transaction takes place with neither party exchanging any personal financial information. The financial institution issues to the consumer on request a one time code that may be used by all the other parties in a transaction to uniquely identify said transaction. The financial institution in issuing a one time code does so using a method supplied by the transaction processor, such one time code will not be identifiable as being related to either the consumer's own personal identity or to the consumer's CHandle. The one time code is unique to the financial institution, and no two consumers of the same financial institution can ever have the same one time code. The one time code is also unique to the transaction processor, such that no other financial institution can issue a one time code that is exactly the same as said one time code. The one time code can comprise of alphanumeric characters. Said one time code can be represented by any standardized method of data display or capture, such as a bar code, text, pictorially, or any method of uniquely identifying the one time code. The one time code can be provided by the consumer to the third party by any means, whether spoken, typed, written, pictorially or electronically; any method that allows the third party to capture the one time code into their systems. The one time code's validity can be time limited. The one time code is, when provided by the financial institution to the transaction processor, to be linked to the CHandle of the consumer to maintain data integrity. The one time code is linked to the MHandle of the merchant in the transaction. The financial institution uses a registration module provided to it by the payment processor in order to issue to each registered consumer a unique CHandle and each registered merchant a MHandle. The module ensures that each registered merchant or consumer is issued with a MHandle or CHandle respectively that is unique in the world, across all countries. Said system that generates the MHandle and the CHandle is not operated by the payment processor but by the financial institution of the merchant and consumer respectively. Said financial institution to keep a record of which one time codes it issues to which MHandle or CHandle. Said financial institution supplies the payment processor with a copy of the MHandle or CHandle once issued so that the payment processor knows that it is a valid identifier. The financial institution is the only party that has knowledge of the identity of the consumer. The party receiving the payment for the transaction will need only the one time code from the consumer as an identifier in order to submit their request for payment to the transaction processor. The payment processor only needs to know the one time code in order to identify to which financial institution it should route the request for payment. The payment processor keeps a record of all the information that is contained in the invoice that is submitted from a merchant. The invoice is associated with a particular one time code and its associated CHandle. The invoice is associated with a particular financial institution for the consumer, said financial institution is derived from the one time code. The invoice is associated with a particular merchant through its MHandle. The payment processor can associate multiple MHandles or multiple CHandles that belong respectively to a single entity, to a single unique code called a moniker. Multiple CHandles would exist where the consumer has more than one financial institution that the consumer is associated with. Said multiple MHandles would exist where the merchant has more than one financial institution that the merchant is associated with. Said moniker can exist for MHandles and CHandles where the entity has multiple roles, acting as a merchant to one party and as a consumer to another. Said moniker is unique to the payment processor systems in the world, across all countries. Said moniker is generated in a process where the payment processor does not know the identity of the consumer or merchant. Said moniker generation is generated by the consumer in a transaction that is validated by the financial institution that is used by the consumer or merchant. Said third party that is requesting payment submits documentation in support of a transaction, herein called an invoice, to the payment processor in the process of requesting payment from the consumer, said invoice to also contain the one time code to be used as the unique identifier of the consumer and the MHandle of the merchant. The invoice may contain the product identification codes of the products being purchased, such product codes being those that are used to identify the product uniquely. Said invoice may contain pricing and quantity information of the products being purchased. Said invoice may contain serial and/or other unique production or supply chain information that uniquely identifies that particular product. Said invoice data remains anonymous in its association to an identifiable consumer, the only identification that is known to all parties is the information on the invoice, which contains no personally identifiable information, or any banking account details. Said transaction can take place anonymously between any two parties, it is not necessary for one of them to be a merchant and the other to be a consumer. Said transaction takes place with neither party exchanging any personal financial information. The database of transactions that results from the payment requests can be queried for the purpose of extracting information. The database of transactions contains information that can be queried but is not linked to any personally identifiable banking or personal identity information, even though it contains the anonymous one time codes or anonymous moniker of the consumer or merchant. Said database of information may be queried in real time. Said database may contain information from anywhere in the world, in particular any payment request/s from anywhere in the world that can be linked to a consumer's or merchant's anonymous identifier can be brought together to create a complete history of the payment requests for said consumer or merchant. Said database contains comprehensive information about products that have been involved in the transactions, and may contain globally accepted product codes such as the UPC code of a product, the serial number of a product, the unit price, the quantity purchased in that transaction, and any other information that the merchant supplies as part of the invoice to the customer. Said database may be linked through to other databases in real or other time, so that a product code may be referred in the database to any other sources of information about the product, its components, its uses, a description of the ingredients that is held by the manufacturer in a different database, other extraneous information about the product of which one example may be a database of the carbon footprint of the product, or any information of any type or content that can be linked to or related to the product. Said information in the databases relate to multiple financial institutions, multiple payment methods, multiple transaction types, and multiple data sources. Said transaction can take place anonymously between any two parties, it is not necessary for one of them to be a merchant and the other to be a consumer. Said transaction takes place with neither party exchanging any personal financial information. Said information about payment requests when supplied to a financial institution allows said financial institution to monitor sales activity of its own consumers in real time, or through historical analysis, with knowledge of who the consumer really is. The information may include any of the information that an external party cares to provide, not limited to: information on the temperature that the product should be stored at, expiry date, ingredients, nutritional information, suggested usage guidelines, or any other information that the external party supplies. The information may be queried in real time. The information so gained about a product may be advised to the consumer, in real time or at some later stage. The information so gained may be used in combination with the profile of the consumer such that the consumer is sent an alert. The information so queried and gained about a product may be done by any method that allows the consumer to connect to the databases of the invention, by a plurality of methods, not being limited to an App, a computer interface, IVR, or any other method. The information may be supplied to any entity that has been authorized to query or view the data, through the use of authentication systems that limit the scope of the access to the data. The information that is both stored and supplied never contains any personal identity information of the consumer, nor does it contain any bank account details of the consumer. In this embodiment, the system may be able to identify unique consumer codes without ever knowing who the consumer is, as that information is stored only with the consumer's financial institution. A system of registering a consumer anonymously through the processor using an embodiment of the above system through the user of the moniker into optional program functionality, such functionality deemed to be Value Added Services (VAS) may include: the ability to be advised when a product that is being purchased contains a certain ingredient; the ability to track warrantee information about the product purchased without having to identify oneself to either the merchant or the manufacturer, confirmation from the manufacturer—particularly of high end goods—that the product that has been purchased is stocked at the merchant that the consumer is dealing with, thereby safeguarding the consumer from counterfeit products. The information that is both stored and supplied never contains any personal identity information of the consumer, nor does it contain any bank account details of the consumer. In this embodiment, the system will be able to identify unique consumer codes without ever knowing who the consumer is, as that information is stored only with the consumer's financial institution. The information that is supplied can be used to track an individual consumer's transaction history. Embodiments of the above system may allow for the capturing or collation of invoice data where the payment for the invoice is by means of cash. Said transactions are brought together with transactions that are non-cash that belong to the same moniker. Said bringing together of various types or methods of payments is facilitated through the anonymous codes that the processor or financial institutions provide to the consumer or merchant. Said bringing together allows the users of this system to bring together their transactions from across multiple financial institutions and so be able to see a complete picture, so done without supplying any personal or financial information to the system. Said cash transaction information is treated in the database of transactions in the same manner as that of a non-cash transaction. Again, all the features in the above description are intended to be exemplary only, a particular embodiment of the invention may not contain all the above features or requirements.

A third embodiment of the invention may implemented as software for a consumer financial institution, software for a merchant institution, and software for a payment processor. The software for the financial institutions may include a handle generator and a one time code generator. This software may be supplied by the payment processor. The payment processor may contain software for logging transactions between merchants and consumers, and may contain a database, processor, computer readable media, and other nontransitory computer equipment to allow the payment processor to facilitate payments from the consumer to the merchant.

### BRIEF DESCRIPTION OF THE FIGURES

FIG. 1 is a high level process flow diagram of an embodiment of the invention.

FIG. 2A provides an example of the processes that are involved in a consumer 300 effecting a transaction whilst physically at a merchant.

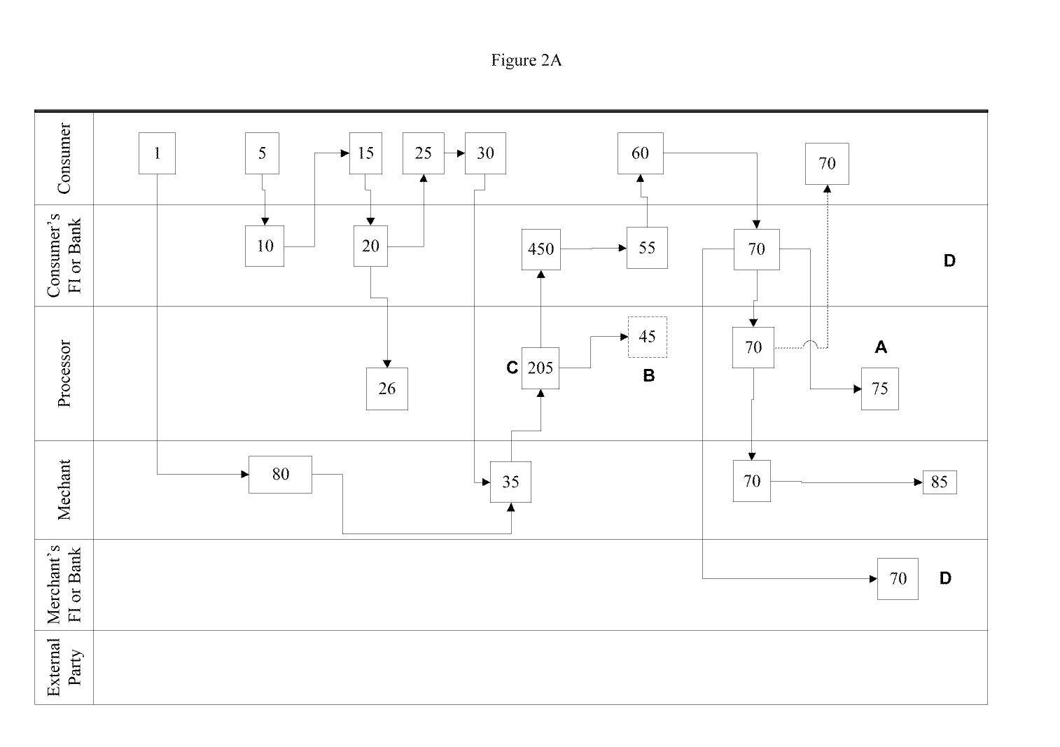

FIG. 2B provides a simplified overview of the settlement process that would take place between financial institutions post a transaction.

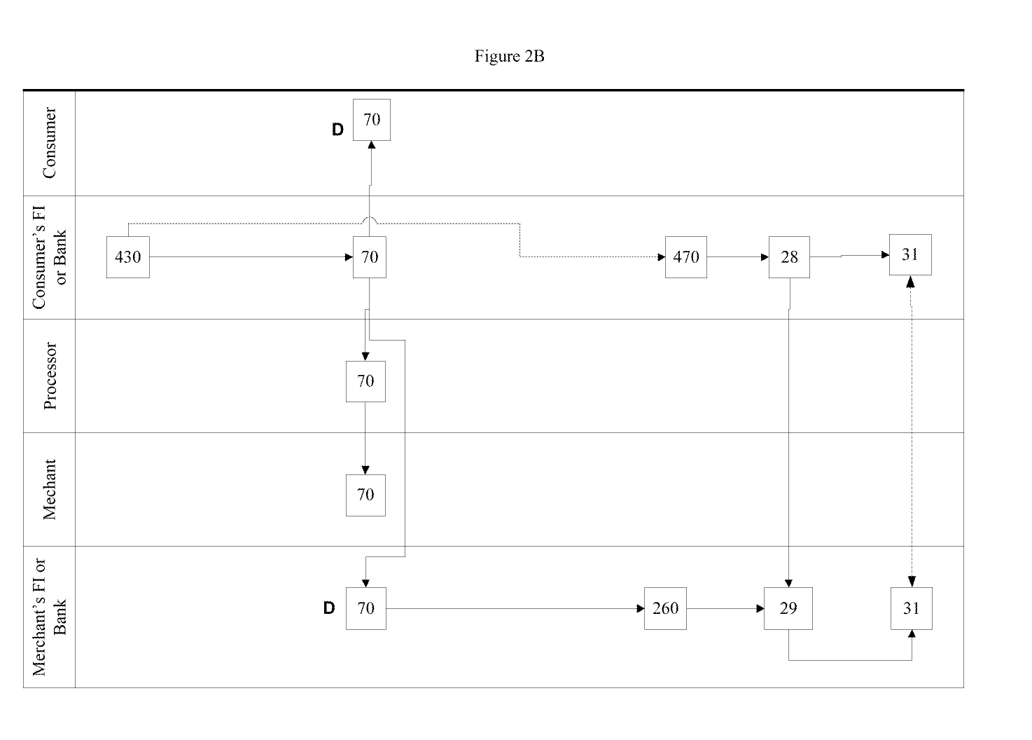

FIG. 3A provides an overview of the processes involved in providing Value Added Services (VAS) to a consumer that was registered for such services, at the point of sale.

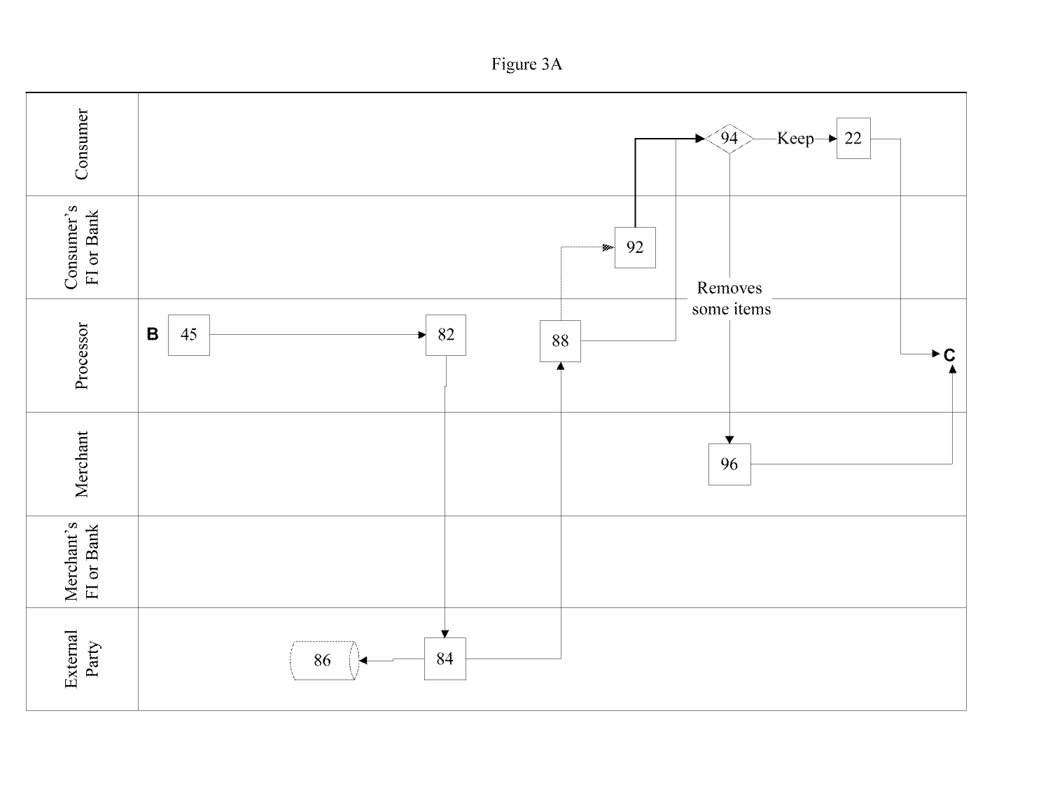

FIG. 3B provides an overview of the processes involved in providing VAS post transaction.

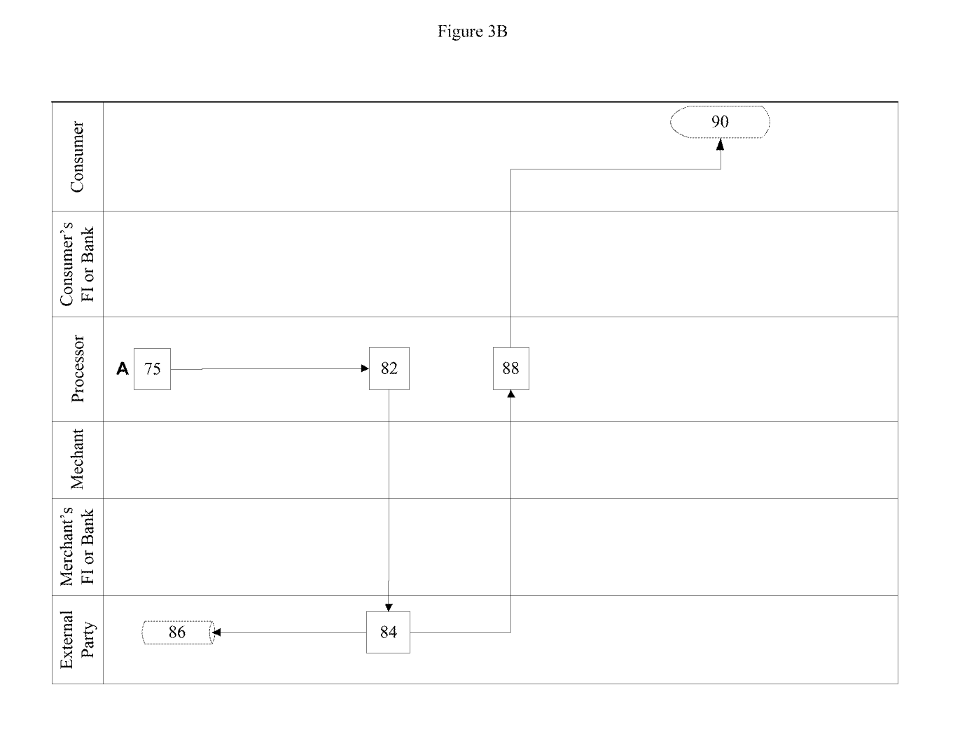

### DETAILED DESCRIPTION OF THE FIGURES

In solving the above problems and providing the above solutions, certain embodiments of the invention have been developed to facilitate consumer-merchant transactions. In one aspect of the invention, it is contemplated that a transaction would occur between a consumer 300 and a merchant 100, wherein a financial institution 400 provides and remits payment to the merchant 100, and a payment processor 200 provides the communication and validation of transaction messages between consumers 300, merchants 100, and financial institutions 400. However, in most embodiments, the payment processor 200 does not receive or send information from the consumer 300 to the consumer 300 financial institution 400C or between the merchant 100 and the merchant's financial institution 400M. A consumer 300 may be a person shopping in a mall for shoes, a company shopping online for a service contract, a person being offered services in exchange for money, a church purchasing electricity, a government agency hiring a contractor, or any natural person or legal entity desirous of consuming and/or purchasing goods and/or services. A merchant 100 is a shopkeeper, distributor, producer, contractor, service company, manufacturer, or natural person or legal entity desirous of providing and/or selling goods and/or services. A financial institution 400 is a corporation or other legal entity engaged in the business of providing financial services to a consumer 300 or merchant 100. The merchant 100 and the consumer 300 may have a financial institution 400 and it may be the same institution or the institutions may be separately owned or controlled. A payment processor 200 contains one or more computers as defined below, wherein the computers contain software for causing the system to carry out a set of instructions.

To effectuate a transaction between a merchant 100 and a consumer 300, the consumer 300 may use a computer. In some cases, the computer may be a small computer such as a cell phone, smart phone, laptop, personal digital assistant, or other portable computer, however the term computer itself should be considered to be any computing device having a processor or circuitry for processing software containing instructions stored on computer readable media (e.g. memory, hard drive). A computer may contain other components such as a display, Ethernet circuitry, memory, bus, hard drive, power supply, or components.

In some embodiments of the invention, the consumer 300 and merchant 400 will need to register 405 an account with a financial institution 400. The financial institution(s) 400 also registers an account 455, 456 with the payment processor 200. Notably, the consumer 300 does not register with the payment processor 200, thus ensuring that the consumer 300 remains anonymous to the payment processor 200. Such registration processes 405 may be done in person, on the phone, or through a web portal hosted by the financial institution 400C or payment processor 200. In certain embodiments, neither the merchant 100 nor the consumer 300 can or does register 405 an account with the payment processor 200. The reason for disabling such a registration 455 is to maintain the consumer 300 and merchant 100 banking information within the consumer's 300 or merchant's 100 financial institution 400M, and not to provide banking information to any third parties, including the payment processor 200. Because computers which contain consumer 300/merchant 100 information are targets for hacking, maintaining a payment processor 200 which does not contain consumer 300/merchant 100 information reduces the risk that a third party can learn of the consumer's 300 or merchant's 100 financial information.

A consumer 300 using a computer may, in paying for a transaction, allow himself or herself to be identified 110 to his or her financial institution 400C (the consumer's 300 financial institution 400C). Element 110 may feature a secure platform for exchanging information in a secure session between the consumer 300 and a consumer financial institution 400C. In response to a direct request from its consumer 300, the consumer's 100 financial institution 400C will then simultaneously forward to the consumer 300 and the consumer's 100 computer a time-limited one time code 135 in a particular format. Such code 135 may optionally be time limited in its validity period. The consumer's 300 financial institution 400C may then send the payment processor 200 the same one time code 135. The consumer may present 120 physically (i.e. by showing the code to merchant) or electronically the one time code to a merchant 100. The merchant 100 will send to the payment processor 200 a message 28 regarding the transaction for which the consumer 300 has supplied a one time code 135, such message would contain, inter alia, the one time code 135 (for example in the header of a message 28) for the transaction being performed and additional information 35 on the goods or service 1 being purchased or solicited. If encryption is being employed, the payment processor 200 may decrypt the header 205 and extract the one time code 135 from the communication 28. The payment processor 200 can then match 230 or compare 220 the one time code 135 from the consumer's 300 financial institution 400C. In some embodiments the message 28 referred to above may contain a merchant identifier (MHandle) 455 (which may also be placed in a header of a message 28) and a full invoice 35 detailing the goods or service being offered to the consumer 300. This communication 28 may optionally be encrypted. In some embodiments, the payment processor 200 will then forward to the consumer's 300 financial institution 400C an abridged 450 form of the information contained on the full invoice 230. The consumer's 300 financial institution 400C may—in the secure session 110 between itself 400C and the consumer 300—forward 450 to the consumer 300 the abridged 450 or full 230 invoice and request confirmation 55 of the transaction. The consumer may then either reject the invoice and cancel 225 the transaction or proceed to authorize 60 the transaction. The computer that the consumer 300 is using may provide the consumer 300 with one or more 420 accounts 475 from which to make payment 480. Payment 480 can be made in whole from one account 435 or in parts 460 from more than one account. 445 After authorizing 60 payment 480, the payment processor 200 may receive a notification 70 from the consumer's 300 financial institution 400C that the transaction has been successful. The payment processor 200 obtains the merchant identifier 455 (for example by decrypting a message 28 header) and extracts from the identifier 455 the financial institution's 400C SWIFT code for the merchant. The SWIFT code is the unique identifier for a financial institution 400 as issued and maintained by the Society for Worldwide Interbank Financial Telecommunication, and is a global standard. The payment processor 200 then sends to the merchant 100 and the merchant's 100 financial institution 400M the result 70 of the transaction, i.e. a confirmation that the transaction was successful and the consumer 300 can then take their goods 85.

In the embodiment just described, a system can be constructed wherein the payment processor 200 never learns the identity of the consumer 300, the payment processor 200 never gets to know the merchants 100 banking details—it only needs to know which bank to send the transaction message 28 to (the transaction message 28 contains the amount of money that is due to come to the merchant's bank from the consumer's bank). In such an embodiment, the consumer 300 does not need to reveal its banking details or personal details to any party involved in the transaction. The consumer 300 in authenticating 110 himself to the financial institution 400C remains anonymous to the merchant 100 as the information in the authentication request 110 is not carried over the network of the merchant 100, but is sent directly to the consumer's 300 financial institution 400C by the consumer 300. Once the consumer 300 supplies to the merchant 100 the one time code 135 that the financial institution 400C has supplied, the transaction database of the merchant 100 will contain the one time code 135, but as the one time code 135 is a unique identifier only for that transaction, the data of the one time code 135 will have little value to hackers or collectors of personal data. Although the code 135 may be stored in the merchant's 100 database, the code 135 is not linked to any personal data. Were the one time code 135 to be used again—or were the invoice 35 presented indicate a different amount or location to what they are expecting—and the consumer 300 was asked for authentication 55 of the transaction, they would cancel the transaction 225 as it would be fraudulent.

The one time code 135 may decrypt into a financial institution 400 identifier (e.g. SWIFT) and a unique code that the bank generates. Part of the unique code is the Date/Time that the code was generated. An additional identifier within the one time code will be unique within the one second of the Date/Time of the bank's systems that generated the code. That is, an additional identifier may be created, but it is only exists once within any Second of time.

| | | | | | | | | | | | | | | | | | | |
|---|---|---|---|---|---|---|---|---|---|---|---|---|---|---|---|---|---|---|
| 1 | 2 | 3 | 4 | 5 | 6 | 7 | 8 | 9 | 10 | 11 | 12 | 13 | 14 | 15 | 16 | 17 | 18 | 19 |

| | | | | | | | | | | | |
|---|---|---|---|---|---|---|---|---|---|---|---|
| Z | A | H | S | B | C | Da | te | Ti | me | One Time Code | Check |

The above is an optional example of a 19-character one time code 135, generated by the financial institution 400 that is identified in the SWIFT Code (position 1 to 6), a short form of the Time to the Second as per that financial institution's 400 computers (position 7 to 10), an 8-character one time code in position 11 to 18, and a check character in position 19 which validates that the entire code meets a defined standard.

Once the transaction has been matched at the payment processor 200, the one-time code 135 is ‘used’ and if it is resubmitted to the financial institution 400C, the financial institution's 400C computer can determine if it's a duplicate (“used”) code and flag it as fraudulent. In those embodiments, the computer of the financial institution 400C may be programmed to not forward the code to the associated consumer 300 for approval. The invoice details 35 that are associated with any one time code 135 may be presented to the consumer 300 prior to the payment 480 being approved, 450 so that the consumer 300 can ensure that the one time code 135 that is sent by the payment processor 200 is for the same goods/services 1 that they are buying.

Having managed the successful completion of a transaction with the only parties that know the identity of the consumer 300, being the consumer's 300 financial institution 400C and the consumer 300 himself, the payment processor 200 will allow the consumer 300 to review on a computer the information that has been saved, namely, the detailed 35 product information. The method of linking the consumer 300 to the payment processor 200 is done by linking the bank-issued registration code (CHandle) 455 that does not identify the consumer in any way, to the payment processor 200. This linking is done in a manner that ensures that they do not need to identify themselves to the platform 200—they remain known only to their financial institution 400C. Once the bank issued registration code 455 is linked with the payment processor 200, the consumer can do various activities, such as track their spending.

In an example wherein the consumer 300 would like to pay for a goods or services 1 with cash, the consumer 300 can use any one time code 135 that has been previously issued to him or her to provide a code 135 at the point of sale with the merchant 100. Cash transactions need not be sent to the payment processor 200 for approval, so the payment processor 200 may not receive the one time code 135 for distribution to the consumer's 300 financial institution 400C, and so the payment processor 200 will not flag any one time codes 135 used for this purpose as fraudulent. The specific one time code 135 tendered to the merchant 100 may be stored with the transaction data in the merchant's 100 cash register 105. The merchant 100 may upload this transaction 35 to the payment processor 200 as information only. The information thus loaded up into the system 200 will be treated in the same manner as a non-cash transaction. In the event that the consumer 300 links with the payment processor 200 the payment processor 200 will send information to the consumer's 300 computer consisting of a listing of all the consumer's 300 purchases 1. This listing may include both cash transactions and those that have been completed electronically through the payment processor 200.

The payment processor 200 may be used in combination with other software platforms or value added services 90—such as a budgeting software application—to allow the consumer 300 to group his or her expenditure into categories that he or she can define for measuring actual spending against a generated budget. By including cash purchases into the system, nearly every type of transaction of money and goods can be recorded, allowing a consumer 300 to have a complete picture of their spending.

Certain embodiments of the invention may provide the following:

A system and method for ensuring that a consumer 300 can pay for a transaction at a merchant 100 without using cash, wherein no personally identifiable information of the consumer 300 is ever provided to the merchant 100. Such a system and method may be configured to avoid capturing any personally identifiable data of the consumer 300 (e.g. no bank account numbers, credit card numbers, no telephone numbers are captured).

A system and method involving: using an optionally time-limited one time code 135 that has been obtained from a consumer's 300 financial institution 400C and providing this code 135 to a merchant 100 as part of the transaction settlement process. Simultaneously (in some embodiments) the consumer's 300 financial institution 400C can provide the same one time code 135 to the payment processor 200. The merchant 100 can send this data 125 along with the invoice details 55 to the payment processor 200. The payment processor 200 can send the invoice details 55 to the consumer's 300 financial institution 400C, thereby bypassing the merchant 100 (i.e. the merchant 100 and the merchant's 100 financial institution 400M never captures or stores a consumer 300 account number 475, name of the consumer 300). The only information that the merchant's 100 financial institution 400M has is the financial institution 400 which was involved in the transaction, and the amount due to be received.

A system and method of a financial institution 400 generating a one time code 465 that ensures that said code 135 is unique in the world to that financial institution 400.

A system and method for presenting to the consumer 300, a summary 450 of an invoice of goods 1 that the consumer 300 is about to acquire as part of a transaction process (such as one of the processes discussed above), wherein the consumer 300 can confirm to the consumer's 300 financial institution 400C that the consumer 300 is involved in said transaction.

A system and method which involves using existing financial institution 400 systems and infrastructure to authenticate 80 a transaction, wherein the consumer 300 can anonymously authenticate a payment from a consumer 300 to a merchant 100 for a specified and identified invoice 35 detailing the transaction.

A system and method of gaining and storing 210 more information relating to an anonymous point of sale transaction—such as product code data 130—than is ordinarily provided to a consumer, storing this information in a central database 210 in anonymous form, and providing an interface 90 to query this information anonymously online.

A system and method of conducting analytical and/or statistical analysis of the transactions that have been managed through the transaction platform, such analysis being completely anonymous in terms of the privacy of data, since no personal information is either linked to, available to, or used by the payment processor 200.

A system and method for using the information from a recorded product code 130 to obtain additional information from an online database 215, such as an expiry date or details on the ingredients. The system and method may communicate this additional information 215 to the manufacturer of the product 1 to register the product with the manufacturer as part of a warranty registering process. This system and method may involve registering a unique serial number associated with the product 1 to be registered. In some embodiments the payment processor 200 would not know who the consumer 200 is because the consumer 200 can be registered through his or her financial institution 400C and not through the payment processor 200.

Certain configurations of the invention may be constructed so that a consumer 300 may be able to view details of his or her purchase history 210 from a store 100 even though neither that store 100 nor the system 200 knows the consumer's 300 identity.

The system and method may provide an interface 90 to the consumer or entity so that the entity can anonymously query 84 information from the payment processor 200. In those embodiments, the system and method provide safeguards to ensure the information being viewed is associated with the entity viewing the information.

In certain configurations of the above systems and methods, an Application Programming Interface (API) 84 may be provided to provide a framework for accessing a database 210 of transactional information with a computer. In certain configurations, the API 84 may provide manufacturers and other 215 organizations in the supply chain with value added services through access 84 to the information 215 without providing them access about the consumer 300 that purchased the product. Such access may be in real time or historical. Such access to the data 210 can be obtained by the entity access devices. The payment processor 200 may be configured so that it does not store personal information of the consumer 300. The API 84 may also provide a framework for allowing consumers 300 or merchants 100 (e.g. manufacturers) a value added service 80 to validate whether a purchased product 1 is a valid or genuine product. This can be applied at any level of the supply chain and is not restricted to the final user of a good. In this embodiment of the invention the validation can take place from one consumer 300 to another 300, where consumer 300 in this instance is not the final consumer 300 but a person that is purchasing or using the product 1 to be either on-sold or used as components in goods. In this embodiment of the invention the payment processor 200 will still not be aware of the identity of the consumer(s) 300 as the transactions are done in a completely anonymous manner.

A system and method for using information from a transaction header 28 (such as an invoice number) wherein the information is used to reconcile a merchant's 100 or financial institution's 400M accounts receivable 26 and/or accounts payable 470 billing records for transactions that are not completed using cash at the point of sale. The system and method may utilize a one time code 135 generated by the use of an algorithm by a consumer's various financial institutions 400C, wherein the algorithm is programmed so that it ensures that the generated code 135 is unique even though various other financial institutions 400 also create one time codes 135. The system and method may utilise a one time code 135 that has an expiry time where after, although the code 135 itself is valid as a code 135 that was issued by a financial institution 400C for the use of the consumer 300, that unless the code 135 so generated is consumed within a certain time period, it becomes stale. Certain configurations of the invention may link a cash transaction to the consumer 300 by using a previous one time code 135 of that consumer 300, uploading the code 135 to the system 200, and including these transactions in the consumer's 300 purchasing history 210 (listing).

Some embodiments of the invention may provide an interface for subscribing a computer device at the point of sale 105, so that various types of computers can be linked to the payment processor 200.

The above methods and system may be constructed so that banking information never leaves the financial institution's 400 own computers; consumer 300 identifiable or personal information never leaves the financial institution's 400C own computers; and/or a consumer 300 does not have to give out his or her personal information to any entity other than a financial institution 400.

Certain configurations of the invention may provide an electronic payment model where transactions are anonymous like cash to all parties except the consumer's 300 financial institution 400C. Some configurations of the above systems and methods may provide direct control to the consumer 300 of the payments 480 out of their account 475, whereas in prior art systems, control of the payment is delegated to a third party (such as in the credit card and electronic wallet models). Some embodiments of the invention may be used to allow a consumer 300 to pay a merchant 100 who does not have specialized equipment or knowledge.

Certain configurations of the invention may provide the financial institution 400C with the ability to present to the consumer 300 an abridged invoice 450 to verify 60 that proposed charges 55 are correct prior to payment 480 to reduce the number of post-transaction disputes which are currently raised between consumers 300 and merchants 100. In such configurations, the financial institution 400C may obtain confirmation directly from the consumer 300 that they are indeed transacting with the merchant 100 for a product having a specified amount.

Some embodiments of the invention may feature the return of a success message 70 containing an invoice number to the merchant 100 to inform the merchant 100 that payment was successfully approved 430. Certain embodiments of the invention may provide full supply chain information 130 scanned at the point of sale 105 (e.g. barcode of the product, the quantity of the product, the pack size, supply chain information, etc) to the payment processor 200.

In the above configurations, the systems and method may be constructed so that there is no need for the consumer 300 to provide proof of identity to the merchant 100 as the financial institution 400C will be authenticating the consumer 300 to the merchant 100 and thus the merchant 100 no longer needs to have any knowledge of the consumer 300, which is all handled by the financial institution 400C. Additionally, the payment processor 200 can capture the supply chain information 130—such as the product code that describes each product 1, the quantity of each product being purchased—with the invoice number and value of the total invoice 35 to the system 200. An invoice number 35 may be used for reconciliation of accounts payable 470 and accounts receivable 26 accounting entries by the consumer's 300 financial institution 400C that approves the payment 430 and the merchant's 100 financial institution 400M that receives the payment 480. Additionally, the merchant 100 can reconcile his or her accounting system with receipts directly from the financial institution 400C.

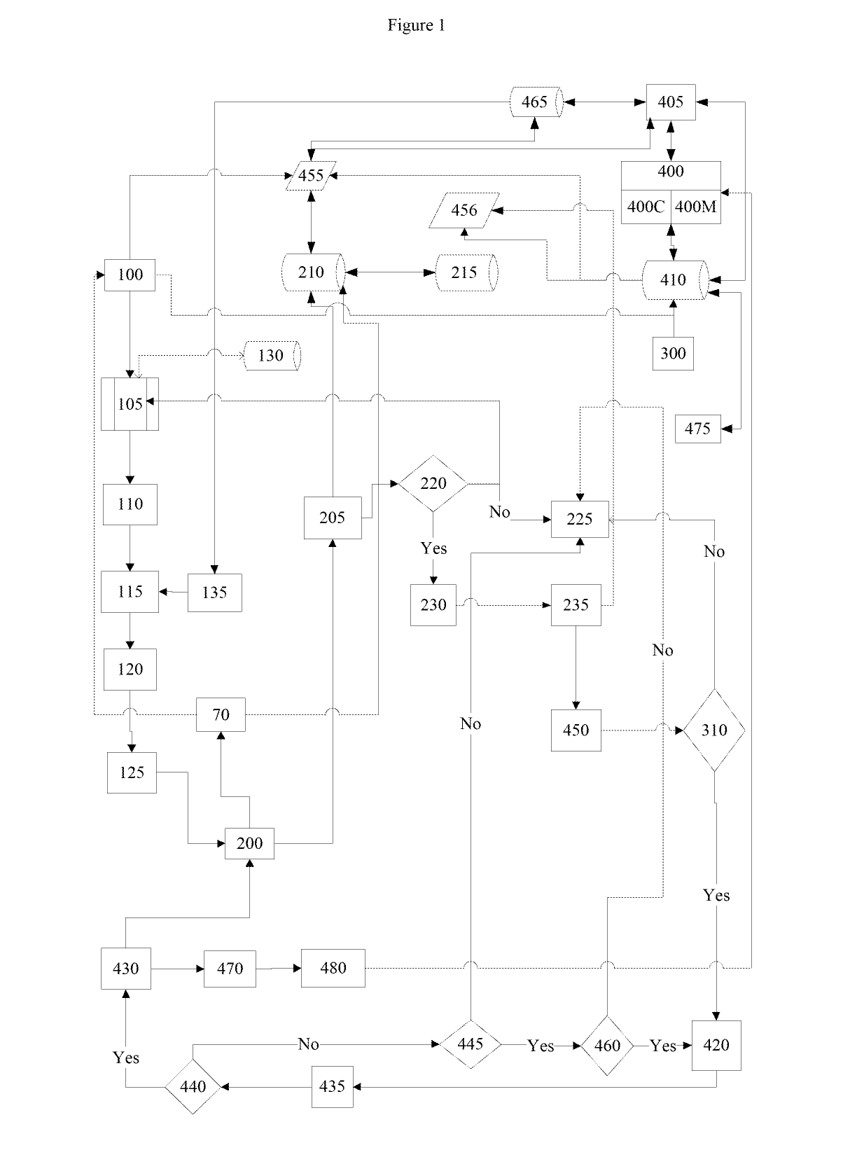

In FIG. 1 is depicted a number of processes that are essential to the system. Merchant registration. In deploying a particular configuration of the invention, a merchant 100 may sign up to use the payment processor 200 by creating an account 405 with their own financial institution 400. This registration process 405 may involve the financial institution 400 creating a unique identifier for the merchant (“the merchant handle” or MHandle) 455. This identifier is used to link the merchant 100 to the payment processor 200 and is only valid between the financial institution 400 of the merchant 100 and payment processor 200. The financial institution 400 and/or the merchant 100 may provide the merchant handle 455 to the payment processor 200. In this manner, the merchant's financial institution 400, merchant 100, and payment processor 200 become linked.

Consumer registration. The consumer 300 can also register with a financial institution 400. The registration process 405 may include processing consumer information and credit worthiness 410. The consumer's financial institution 400 can generate a unique ID for that consumer to be used as a ‘handle’ or identifier in the invention of the consumer (“consumer handle” or CHandle) 455. The consumer's financial institution 400 provides the consumer handle 455 to the payment processor 200. During the registration process 405 the consumer 300, consumer financial institution 400, and payment processor 200 become linked.

Such system/s that are used by the financial institutions 400 to generate the MHandle 455 and the CHandle 455 will be supplied by the processor system 200, and will ensure that there is no duplication anywhere in the world of either of the MHandle 455 or CHandle 455.

The consumer 300 may have more than one financial institution 400 with which they have an account 475. In this instance, for the consumer 300 to see all of their transactions in one place they would need to link the CHandle 455 from the one financial institution 400 with the CHandle 455 of the other financial institutions 400. The consumer 300 has the ability in the system 200 to create a Moniker with any one of the financial institutions 400 and to process a transaction at the second institution 400 that allows the consumer to 300 create a linkage between two or more CHandles 455. Functionality is provided that allows for validation of the transaction by the consumer 300, at the same time still ensuring that no personal information leaves the financial institution 400. The functionality also ensures that the Moniker remains unique across the world.

In some embodiments the payment processor 200 does not “know” or have records of the name of consumer 400 which is linked with the consumer handle 455. Additionally, the payment processor 200 does not know the financial institution's 400 account 475 which is linked with the consumer 300. The payment processor 200 may know the name of the merchant 100 and which financial institution 400 the merchant 100 uses.

The consumer's 300 financial institution 400, using one or more computers, can generate a new time-limited one time code 135 for each transaction. The code 135, account 475, consumer handle 455, etc may be embodied as elements within a database 410 controlled by the consumer's 300 financial institution 400. The consumer's 300 financial institution 400 may use database access software to access the database 410. The merchant's 100 financial institution 400 may also have a database 410 with database access software.

The one time code 135 may take a variety of forms, an example is shown below:

| | | | | | | | | | | | | | | | | | | |
|---|---|---|---|---|---|---|---|---|---|---|---|---|---|---|---|---|---|---|
| 1 | 2 | 3 | 4 | 5 | 6 | 7 | 8 | 9 | 10 | 11 | 12 | 13 | 14 | 15 | 16 | 17 | 18 | 19 |

| | | | | | | | | | | | |
|---|---|---|---|---|---|---|---|---|---|---|---|
| Z | A | H | S | B | C | Da | te | Ti | me | One Time Code | Check |

ZAHSBC is the SWIFT code for the bank 400, date and time are the time the code was generated, and one time code is a random 8 digit code that is unique within that second of time, check is a character that validates that the entire code meets a defined standard.

The transaction. The consumer 300 selects some goods or services 1 at a merchant 100. The merchant 100 rings up the goods or services 80 and may use a scanner (label/RFID reader) 105 to obtain a serial number for the goods or services. The serial number may be a UPC, an IMEI number, a SKU, model number, etc 130. Next, the merchant may present the total cost of the goods to the consumer.

To pay for the goods 1, the consumer 300 obtains 25 a one time code 135 from his or her financial institution 400. To do so, the consumer uses his or her computer to send and receive data with the financial institution 400. In today's time, the consumer 300 may have a mobile app such as iPhone App or an Android App to access, send, and receive information 5. The financial institution 400 may use authentication rules 10 to establish that the consumer 300 is the person he or she is representing to be (user name, password, challenge question, etc.) The financial institution 400 itself chooses what methods and modes of communication it will allow for a consumer 300 to authenticate themselves to the financial institution 300, which may change over time. Neither the merchant 100, the merchant's 100 financial institution 400, nor the payment processor 200 receives any information during this information exchange. The consumer's financial institution generates the one time code on request 15, and transfers 20 it to the consumer 300. The consumer's 300 financial institution 400 may also send the one time code 135 to 26 the payment processor 200. The consumer 300 may then supply 30 the one time code 135 to the merchant 100. The step of supplying may be carried out by utilizing a mobile app or webpage that can generate a barcode, or the consumer's 300 computer can display a code. The consumer 300 can also call the financial institution 400 to receive the code over the phone, etc.

The merchant 100 may associate 35 the one time code 135 with the transaction. The merchant 100 may forward 35 the entire invoice (which may include the one time code, UPC, EAN, and/or GTIN codes, number of units, price per unit, 130) to the payment processor 200. The step of forwarding 35 may be carried by sending a message for example, which may contain a header. The merchant's 100 computer may place the one time code 135 into the header to assist the payment processor 200 in processing 205 the message. The merchant 100 may include a merchant handle 455 in the header. Since this communication may contain sensitive information, the message may be encrypted.

The payment processor 200 can receive the message 205 from the merchant and decrypt the message. In some embodiments, the payment processor 200 will select the one time code 135 from the message to determine 40 which financial institution 400 originated the one time code 135. Once determined, the payment processor 200 may send the total cost 35, header information 35, merchant handle 455, one time code 135, and any other suitable information to the consumer's 300 financial institution 400. The payment processor 200 may also send this message 40 encrypted.

The consumer's 300 financial institution 400 may also decrypt the message 450 and send a query 55 to the consumer 300. The query 55 may include a copy (redacted possible) of the information relating to the purchase 35 and a query 55 to the consumer 300 to confirm 310 that he or she is attempting to buy these goods or services. Such a request 55 can be sent in multiple ways, e.g. the consumer's 300 financial institution 400C can send an SMS message or an email, or confirm via a webpage, etc. Upon receiving the request, the consumer 300 can confirm or deny that he or she is about to consummate a transaction with this merchant 100. If confirmed, the consumer can be asked for authentication 60 (e.g. password) to make payment 480 to the merchant 100.

In some embodiments, the consumer's 300 financial institution 400C can offer the consumer 300 a choice of accounts 475 that the consumer 300 has with the financial institution 400. The account 475 could be a checking account, mortgage account, credit card account, savings account, or other account the consumer 300 has with the financial institution 400C which has been linked with the payment processor 200. In some embodiments, the financial institution 400C may send the consumer 300 a copy of the balance available on any of the accounts 475 shown. If the consumer 300 chooses an account 435 that has insufficient funds 440, the financial institution 400C may prompt 420 the consumer 300 to choose 460 another account 475 or make a partial payment 445 from the chosen 420 account 475. If a partial payment 445 is selected, the consumer 300 may be prompted 460 to either choose another account 475 or to make a partial payment 445 from the chosen account 475. The computer the consumer 300 is using may request the consumer 300 confirm the final 60 payment 480 amount before authorizing a payment 480 to be made to the merchant's 100 financial institution 400M.

To transfer the money to pay for the goods or services, the consumer's 300 financial institution 400C can inform the merchant's 100 financial institution 400M that payment 480 has been approved 430 (e.g. a message or email may be sent). Note, in some configurations, the merchant's 100 financial institution 400M and consumer's 300 financial institution 400C are the same entity. When the consumer's 300 financial institution 400C sends the merchant's 100 financial institution 400M the message 28, the merchant's 100 financial institution 400M can determine the identity of the merchant 100 from the merchant's 100 handle 455 which may be included in the message 28. The consumer's 300 financial institution 400 can send a message 70 to the payment processor 200 to inform the platform 200 that payment 480 has been approved 430. At this point, the payment processor 200 may not be aware who the consumer 300 is—indeed in some embodiments the payment processor 200 never learns who the consumer 300 is.

In some embodiments of the invention, the payment processor 200 will have and maintain for a period of time, a record of transactions 210 that proceed through it. In some cases, the transaction information in the message will be scant, and in other cases it will be detailed with product codes that, when looked up by the system, may not only identify the product (name, brand, pack, quantity) such as is the case with UPC codes; but may also include batch numbers, expiration dates, GTIN, and GPC numbers. GTIN and GPC can provide information about the product including whether the product requires refrigeration or not. This information may be provided to the consumer 300 as a value added service 90 when requested or subscribed to either in real time 45 or post the transaction 75 event. Such information may be derived from transaction databases 210 in more than one country in the instance that the consumer 300 has transacted in more than one country. In some embodiments, the database 210 of the payment processor 200 may contain an interface for providing data 210 responsive to queries. Such queries may be run in real time or historically. The queries can be sent from a computer. As described previously, the payment processor 200 can track purchases that are settled by cash—i.e. not directly through the banking system—to be included in the history of the purchases 210 that the consumer 300 makes, so when the consumer 300 queries the database 210 of the payment processor 200, the reply from the platform 200 can include all the purchases (cash and electronic) made by the consumer 300.

Some configurations of the invention, feature software for enabling peer to peer (P2P) payments. The distinction here is that the first peer (or other legal entity, company, church, government office, etc) is not acting as a consumer 300 and the second peer is not acting as a merchant 100. Such a situation might arise when a payer wishes to send money to a payee, but the payee is not offering any goods or services. Neither party needs to exchange or provide any personal financial or personal identity information.

The payer wanting to make the P2P payment could perform the following steps to make the payment. The payer would ask the payee to provide his or her ‘handle’ 456 or previous one time code 135 that the payee has used. Payer would access his or her account at the payer financial institution 400 systems; payer would indicate that he or she wants to make a payment to another person using the payment processor 200. Payer's financial institution 400 would request the payer to provide the code 135 that he or she has received from the payee, generate a new one time code 135, and send the code 135 and handle 455 to the payment processor 200. The payment processor 200 would then use the one time code 135 to determine that this was a P2P payment and from the one time code 135 know which financial institution 400 sent the one time code 135 to the payment processor 200. The payment processor 200 would from the handle 456 that was provided, return to the payer's financial institution 400C the information of the financial institution 400M that needs to receive the payment. The payer's financial institution 400C would then send the payment to the payee's financial institution 400M using the handle 456 as a reference. The payee financial institution 400C would then determine from the handle 456 which account 475 was to be credited and would credit that account 475. The payee financial institution 400M would then send a message 28 to the payer financial institution 400C advising the payer financial institution 400C that the payment was successful. The payer financial institution 400C would then send confirmation to the payer that the payment was made. Accordingly in some embodiments of the invention, a payee can receive money from a payer without the payee providing banking information to the payer. In such an embodiment, the banking information may be maintained within the banking system only.

In certain embodiments of the system the consumer 300 may have enrolled 80 with the system 200 for value added services (VAS). Such services would typically take advantage of the information about the transaction to be able to deliver content to registered users, that is not restricted to any of: additional information about the product purchased, information on complementary products, or any service or offering that relies on the knowledge about the consumer 300 and the purchases 1 that he is making. The VAS may be offered by the system 200 or by a third party that is accessing the consumer's information through the system. In all instances the consumer 300 remains anonymous to all other parties with the exception of the consumer's 300 financial institution 400C. The parties are making decisions based on the actual purchasing of the consumer 300 and not on the demographics of the consumer 300, simply because the system 200 contains no demographics of the consumer 300.

In some embodiments of the system it is foreseen that that the majority of purchases by a consumer 300 will be effected either through the system 200 or, in the case of cash purchases, be reported to the processor 200. This data that is collected is what is queried anonymously by those users of the reporting system that have been given permission 84.

Such VAS may not need to be only a report but in one embodiment may be a means of allowing the consumer 300 to interact with other consumers 300 regarding aspects of their transactions, such interaction between consumers 300 remaining anonymous to the system 200 even though the system 200 has provided functionality to allow this to be effected. An example of this is where the consumer 300 has made a purchase and a merchant 100 is offering rewards of any description for the consumer 300 to influence their circle of friends and said friends to purchase product/s from that merchant 100. In such an embodiment the system 200 may facilitate a means for a merchant 100 to run a reward or loyalty program in a completely anonymous manner, such that the merchant 100 never needs to know who the consumer 300 is, yet the purchasing history of that consumer 300 from that merchant 100 and all other merchants 100 who use the processes 200, is known to that merchant 100. The processor 200 can provide the means for the consumers 300 to link themselves to each other in a manner that is anonymous to the processor 200 and the merchant 100, yet the consumer 300 has certainty about the identity of the person that they are linking to. In such an embodiment a consumer 300 may purchase an article of clothing that they managed to get at a good price. The sharing of that information via the processor system to their linked friends (effectively other consumers 300) is accompanied by the one time code 135 that was used to purchase that item. If the friends now acting as consumers 300 themselves purchase that same product from that same merchant 100 within certain parameters, then the consumer 300 that did the referring to the friends may receive some benefit for having passed on the information about the purchase, in a manner that is anonymous to the processor 200, to said friends. In certain embodiments the rewards may be monetary, in other embodiments, not. In some embodiments the party receiving the information about a product may receive a reward in addition to the consumer 300 sending the information. Those skilled in the art will recognise that there are many options available to be implemented in the area of information that is supplied, received, or linked to.

1. A payment process for enabling a consumer to make a payment to a merchant, said process utilizing: a consumer account at a financial institution registered with the consumer, a merchant account at a financial institution registered with the merchant, and a payment processor having a database; said process comprising the steps of:
a) providing the consumer with a secure session to enable the consumer to send confidential information to the consumer's registered financial institution; said secure session containing no code or instructions to enable or allow the consumer to send confidential information to any entity other than registered consumer financial institution;
b) maintaining at all times confidentiality of the consumer's confidential information, and ensuring that the merchant does not and cannot obtain access to the confidential information;
c) said payment processor issuing instructions to the consumer's financial institution on how to generate a one time code; said instructions requiring:
i. the one time code not to contain any confidential information about the consumer; and
ii. the one time code to be unique, meaning that two financial institutions will not issue the same one time code; nor will the same financial institution issue two identical one time codes;
d) the consumer requesting a one time code from the consumer financial institution;
e) the financial institution using a one time code generator to create the one time code; and associating the one time code with a particular CHandle in a database controlled the consumer financial institution;
f) the consumer providing the one time code to the merchant;
g) the merchant submitting a payment request to the payment processor to obtain payment from the consumer via the consumer's registered financial institution; said payment request containing an invoice, the one time code, and an MHandle associated with the merchant;
h) the payment processor using the one time code to determine which financial institution to transmit the merchant's payment request to;
i) the payment processor transmitting the payment request to the consumer's financial institution for payment approval;
j) the financial institution determining which account to transmit payment from by referencing a database which links the one time code with the CHandle;
k) said financial institution using the secure session to send the consumer associated with said account an authorization request to make payment;
l) said consumer transmitting a response to the financial institution using the secure session;
m) said financial institution sending the response to the payment processor;
n) if the response is a positive authorization to pay the merchant; said payment processor sending a positive confirmation notice to the merchant indicating that the payment request was authorized;
o) if the response is a negative authorization to pay the merchant; said payment processor sending a negative confirmation notice to the merchant indicating that the payment request was declined;
p) if the response is a positive authorization to pay the merchant; said financial institution making payment to the merchant account at the financial institution registered with the merchant;
q) the consumer financial institution sending payment to the merchant financial institution by determining a bank identifier from the MHandle included in the payment request, and using the bank identifier to determine which bank to pay;
r) transferring payment and a copy of the MHandle to the merchant financial institution;
s) the merchant financial institution determining which merchant account to credit by referencing a database containing an association of merchant accounts with the MHandle;
t) sending the merchant a message the account associated with a particular MHandle has been credited.

2. (canceled)

3. The process of claim 1 wherein the MHandle includes an identifier for the merchant financial institution and a unique number used to determine the merchant account.

4. The process of claim 1 wherein the one time code includes an identifier for the consumer financial institution, a time code, and a unique number used to determine the consumer account.

5. The process of claim 1 wherein the financial institution checking to determine whether there is sufficient funds in the consumer's account to make the requested payment; and if the financial institution reaches a negative determination, sending a message to the consumer that there is insufficient funds in the account to cover the purchase, and sending the payment processor that the payment request is declined.

6. The process of claim 1 comprising the step of: the consumer financial institution sending the payment processor the one time code, after it sends the consumer the one time code.

7. The process of claim 1 comprising the step of: the consumer providing the one time code to the merchant via a mobile device, said one time code represented as a bar code.

8. (canceled)

9. (canceled)

10. The process of claim 1 comprising the steps of:
a) registering the consumer financial institution with the payment processor by providing a first unique financial institution identifier to the payment processor, and the payment processor sending the consumer financial institution a handle generator which utilizes the unique identifier to generate a CHandle;
b) registering the merchant financial institution with the payment processor by providing a second unique financial institution identifier to the payment processor, and the payment processor sending the merchant financial institution a handle generator which utilizes the unique identifier to generate a MHandle;
c) registering the consumer to effect payments with the payment processor by the consumer financial institution providing a registration module, having the consumer select an account to register, and having the consumer financial institution generate a CHandle based on the account, the first identifier, and a first unique number;
d) registering the merchant to receive payments with the payment processor by the merchant financial institution providing a registration module, having the merchant select an account to register, and having the merchant financial institution generate a MHandle based on the account, the second identifier, and a second unique number.

11. The process of claim 1 comprising the step of the consumer financial institution linking the one time code with the CHandle so that a database at the consumer's financial institution records which one time code is associated with which CHandle.

12. (canceled)

13. The process of claim 1 comprising the step of:
a) the payment processor generating a record of payment requests submitted by a merchant including the one time code, the amount requested, and the MHandle; and
b) the payment processor determining the CHandle from the one time code.

14. (canceled)

15. The process of claim 1 wherein the payment request additionally comprises:
a) product identification codes of products being purchased by consumer, and
b) pricing and quantity information of the products being purchased.

16. The process of claim 1 wherein the payment processor's database contains:
a) CHandles, MHandles, and one time codes;
b) no personally identifiable banking or personal identity information, and
c) information about one or more products that have been purchased by one or more consumers.

17. (canceled)

18. The process of claim 16 wherein the database contains information includes product codes of the products purchased, a quantity of items purchased in a single transactions, and unit pricing of the product.

19. The process of claim 16 wherein the database contains information on the temperature that the products should be stored at, expiry dates, ingredients, and nutritional information.

20. The process of claim 16 wherein the payment processor provides a value added service by alerting a consumer when a product purchased contains a certain ingredient.

21. The process of claim 16 wherein the payment processor provides a value added service by tracking warranty information about the product purchased without providing information about the consumer to the merchant or manufacturer of the product.

22. The process of claim 16 wherein the payment processor provides a value added service by determining whether the merchant has the product to be purchased in stock.

23. A payment process for enabling a consumer to make a payment to a merchant for a transaction, said process utilizing: a consumer account at a consumer financial institution, a merchant account at a merchant financial institution, and a payment processor having a database; said process comprising the steps of:
a) performing a consumer registration process wherein the consumer registers his or her account at the consumer financial institution with the payment processor's database;
b) performing a merchant registration process wherein the merchant registers his or her account at the merchant financial institution with the payment processor's database;
c) providing the consumer with a secure session to enable the consumer to send confidential information to the consumer's registered financial institution; said secure session containing no code or instructions to enable or allow the consumer to send confidential information to any entity other than registered consumer financial institution;
d) maintaining at all times confidentiality of the consumer's confidential information, and ensuring that the merchant does not and cannot obtain access to the either the confidential information;
e) the consumer utilizing the secure session to obtain a one time code for identification of the transaction;
f) the financial institution supplying a one time code to the consumer and the payment processor;
g) the consumer supplying the one time code to the merchant;
h) the merchant generating a payment request comprising the one time code and an invoice to the consumer;
i) sending the payment request to the payment processor;
j) the payment processor receiving the payment request, and from the one time code, identifying which consumer financial institution to send the payment request to;
k) the payment processor forwarding the payment request through to the identified consumer financial institution for authorization by the consumer;
l) the consumer financial institution receiving the payment request, and using the one time code, determining which consume account is associated with the payment request;
m) the consumer financial institution communicates the payment request to the consumer for approval;
n) the consumer approving the payment request from the financial institution, thereby authorizing payment;
o) the financial institution sending a message to the payment processor that the payment has been approved;
p) the payment processor sending a message to the merchant that the payment has been approved; and
q) the consumer financial institution transferring funds to the merchant financial institution.

24. The process of claim 23 wherein the payment request contains product codes that are part of an accepted standard that allows for identification of a product being purchased.

25. The process of claim 23 wherein the payment request contains information about the price and quantity of products or services being purchased.

26. The process of claim 23 wherein the payment request contains supply chain information about products or services that are being purchased.

27. (canceled)

28. (canceled)
